(19) United States
(12) Patent Application Publication
(10) Pub. No.: US 2002/0111879 A1
(43) Pub. Date: Aug. 15, 2002

(54) Method and system for selecting and purchasing products via a communications network

(76) Inventors: Antonio Melero, Verona, NJ (US); Salvatore Antonio Natoli, Cedar Grove, NJ (US); Ralph Valles, Clifton, NJ (US)

Correspondence Address: Antonio Melero, c/o Supplyhound. com, 392 Union Boulevard, Totowa, NJ, 07512-2562, US

(21) Appl. No.: 10/074,675

(22) Filed: Feb. 12, 2002

Related U.S. Application Data
(60) Provisional application No. 60/268,435, filed on Feb. 13, 2001.

(51) Int. Cl. G06F 17/60

(52) U.S. Cl. 705/26

(57) ABSTRACT

An electronic commerce method and system for selecting products and creating purchase orders via computer network. The system consists of at least one user operated client computer, and a merchant operated server computer system that processes requests from the client, creates purchase orders, and manages multiple web browser windows within the client. The system features four web browser windows representing four basic functions performed repeatedly and iteratively in purchasing products: “catalog window”, “product window”, “information window”, and “order window”. The system further provides a method to control which window the server output is displayed in to maintain system integrity. The system and method enables the user to switch from one window to another to access any one of the purchasing functions in a single action. The system incorporates a catalog containing a plurality of categories within a single web page and arranged in hierarchical form for efficient single-page access without scrolling. The system further incorporates product selection pages accessed from the catalog in a single action and which enable the user to view and select a plurality of products within a single web page, and submit in a single action said plurality of selected products and the desired quantities of each to the server for purchase. The system and method enable a greatly optimized, much faster and efficient overall purchasing process when compared to prior art, and more particularly where the user orders multiple products in a single order such as in the field of industrial and commercial supplies.

### BACKGROUND OF THE INVENTION

The invention relates generally to the location and selection of products, namely goods and/or services, for purchase, and the creation of purchase orders for electronic commerce and, more particularly, to an improved business automation method and system for selecting and ordering products through the Internet or an intranet.

Computers for business use today are generally interconnected through communications links to form networks. Computer networks that depend on web browser software as a means of interfacing with one another are generally referred to as a net or a web. An Intranet is a network that links computers where access to and between said computers is limited to computers within an organization's own private network. The Internet, also referred to as the World Wide Web or WWW, connects computers through an unrestricted public external global computer network. Computers connected to the Internet or connected within an intranet are able to communicate and exchange data and are able to process business functions or transactions. These business functions or transactions, collectively referred to as electronic commerce or e-commerce, include displaying product data, processing product selections, creation of requisitions (equivalent to a product list or “market basket” in certain e-commerce systems) from selected products, creation of purchase orders from finalized requisitions, communication of purchase order data to merchants/suppliers, data storage, update and retrieval, and general processing of product, purchaser and order data. The typical electronic commerce transaction occurs when a user (buyer, purchaser, shopper) operating a computer (“the client” computer) utilizes the client's web browser software, such as Netscape Navigator.TM or Microsoft Internet Explorer.TM, to access a server computer system (“the server”) which hosts or serves a virtual store website. The client and the server may be connected via the Internet (“online”) or via an intranet. This connection may be hard wired, via telephone line or via a high bandwidth service connection (such as ADSL, DSL, frame relay, cable modem, T1, T3), or wireless. The user submits requests to the client through various actions from various types of input devices directed at a link, such as a button, a hypertext link or a linked graphic, which link has associated with it a command that is executed by the browser when the user clicks on the link. The server processes the client's request using a web server and a data server and returns data to the client in markup language format, such as Hypertext Markup Language (HTML), or Extensible Markup Language (XML), which is interpreted by the client's web browser and converted to a graphic representation of the data which is then formatted and displayed as a web page for the user. The user then interacts with the web page using the client's input devices as needed to submit data and instructions that the client processes to further interact with the server.

A great deal of emphasis and effort has been placed in the last few years on e-commerce, which is also described in industrial and commercial business circles as web-enabling the procurement process. This is on the belief that web or Internet based purchasing will dramatically reduce the effort and cost of purchase transactions over previous methods. The first target of e-commerce efforts has centered around sales of consumer products via the Internet, commonly referred to as business-to-consumer or b-to-c e-commerce. Famous names such as Amazon.com.TM and ToysR'Us(TM).com have emerged, as new and traditional firms have developed systems for placing online orders. Those systems, however, are only marginally efficient due in many cases to poor layout and functionality and to their overwhelming reliance on quirky search engines that often take several tries or return too many unwanted items for each product searched. Recently, a test of consumer e-commerce sites revealed that over one third of the shoppers failed to complete their shopping because they found the site too difficult to use, and over half of the search attempts using the site's search engines failed. Yet, while the systems are not always efficient in terms of searching for products or accessing the various procurement functions necessary to complete the purchase of products, consumers have still found them very convenient and often cost-effective. Why? In direct-to-consumer sales, the number of items or different products ordered per e-commerce transaction is very small, generally one or two items, and the benefit to the consumer in terms of convenience can be great if it saves a trip to a store, saves having to shop in several stores for an item, or simply allows one to shop in the comfort of home. Consequently, retail consumers do not mind using a system that isn't very fast, or very efficient and have embraced e-commerce cheerfully in many product categories. Sales of industrial and commercial supplies, however, are very different in nature from retail sales. First of all, an order for such products typically has several items, and sometimes several dozen or more items are placed in a single order at one time. Also, the person placing the order has many work activities that compete for their limited work schedule and there is little or no “idle time” which could be dedicated to placing orders if one has to spend undue amounts of time searching and selecting for purchase a diversity of products. It is often simpler and more time-efficient for a buyer to look up the items in a printed catalog, write down the information, and simply fax or phone in a list of the items needed to a supplier. The supplier handles the order and returns an acknowledgement to the buyer, resulting in less time expense on the part of the buyer than relying on prior art methods. Regarding convenience and savings in travel time, industrial and commercial supplies are almost always delivered, so the buyer does not spend time traveling anywhere to procure the products. As one can see, the benefits that current e-commerce technologies offer as inducements to retail shoppers would typically not provide any benefits to a buyer of industrial and commercial supplies.

Still, many opportunities exist to optimize the process of purchasing industrial and commercial supplies. The current methods sought to be replaced include EDI (electronic data interchange), direct buyer-to-merchant computer links, FAX, phone, and traditional paper transactions, in relative descending order of sophistication and automation. Even some of the more sophisticated “order management systems” still rely largely on the buyer searching on their own for product information and, although the product information is transcribed to an electronic system, many even still rely on a fax to transmit the order to the supplier. E-commerce, it is believed, will replace all those older technologies with a more efficient way to find and order industrial and commercial supplies.

The costs of Procurement are significant for any business enterprise. Estimates vary considerably, but it is generally thought that a purchase order transacted by conventional means (EDI, phone, fax, paper) costs anywhere from $75 to $150 each, with most enterprises quoting numbers around $100. In contrast, it is estimated that an order processed by an efficient, true e-commerce system could cost as little as $10 to $20. Clearly the incentive is in place to achieve maximum efficiency in the electronic commerce arena, but current systems, sadly, have fallen short of delivering those savings due to inherent inefficiencies.

A survey of prior art for business-to-business or b-to-b e-commerce procurement systems reveals that the systems currently available rely on the same unwieldy technology and methods as the b-to-c systems although there have been some improvements. The addition of certain parameters to databases allowing “parametric searches” and the use of “fuzzy logic” data comparison functions has effected a slight, but not significant enough, improvement on search method performance. Users are still saddled with search methods that can only efficiently process requests limited to a few keywords and still return too many items and often not the item desired. Searches often require multiple search attempts or paging through sometimes three or four web pages before finding the item. Also, items can typically be searched only one at a time, creating an enormous inefficiency as one is forced to return to the search page, and at times having to “page back” through two or more web pages, and wasting time while the pages “download,” before reaching the search page again. Some systems have created online catalogs in an attempt to arrange and present items to the buyer so it's easier for the buyer to look up products. Those online catalogs, however, are often fraught with deficiencies. Many offer a limited selection of items due to the inherent limitation of space in a web page display when using commonplace product information arrangement techniques, so that it is not worthwhile for the user to spend time selecting a few items online only to have to then order the rest through conventional methods. That approach creates two orders, one of them conventional, negating the possible savings in procurement costs. Other systems have electronic catalogs with many items, but accessing the item data is not easy since they typically rely on search engines, with their attendant limitations, as the only interface between the user and the catalog. Some catalogs have an interface page which relies on lists of item categories that, when one is selected, cause the download and display of a web page with a subordinate item category list and when one of those categories is selected it leads to the download and display of another lower tiered category, and so on. In such systems it's not unusual to have to suffer through several download delays while iterating through three or four web pages before reaching the one with the desired item, only to have to repeat the process for subsequent items. Still others attempt to present a large number of items, but if the list is comprehensive enough, it is so long that it takes a great deal of time to download and cannot fit within a single web page screen even within a large screen display monitor, and the user is forced to spend a great deal of time scrolling beyond the bottom of the page until the desired category or item is found. And if the returned search results are many and are arranged in page-by-page format, a very common technique, one must continue to iterate through downloaded pages before arriving at the desired item. A further problem exists with many of the larger electronic catalogs since they typically are built as a composite of the individual catalogs of several suppliers. As a consequence, there is an inordinate amount of item duplication and the added problem of different descriptions and even different part numbers for multiple instances of the exact same item.

Regarding access to the various purchasing functions, many providers of e-commerce software have taken the approach of placing the controls for the critical functions of their purchasing systems in one main web page with the assumption that it is more efficient to control those functions from a central location. Doing so, however, compels the user to keep returning to the control page having to go through at least one and often more pages and often endure download delays. Another problem inherent in many systems is that they place purchasing functions in successive order in the website but the server directs the download to the active window replacing the contents of that window. If that window contained a product selection page or an information page that the user would like to return to, the user must page back the browser, again through several pages sometimes, and often wait for the desired page or pages to be downloaded. In most systems, if the user needs additional product information, the user will typically be given a choice to select a hypertext link that will retrieve more information and display that information in the same window that the product was displayed in, causing the user to have to page back in order to select the product.

In summary, by the time a buyer is finished successfully locating, say even just a half-dozen, different items with these inadequate search capabilities and purchasing functionalities, the buyer might as well have looked them up in a printed catalog, written the item information down on paper, and faxed the order in to the supplier. The difficulties outlined above, we believe, are the greatest deterrent to date to widespread deployment of e-commerce systems for the procurement of industrial and commercial supplies.

It would, therefore, be desirable to provide an electronic commerce system and method that manages the basic purchasing functions within separate and distinct web browser windows; that would enable the user to rapidly search a catalog where item categories are arranged in hierarchical form within a single page without need for scrolling; that would enable the user to alternatively be able to search using a keyword search; that would enable the user to be able to access and view the product selection pages, or access and view additional product information, or access and view the requisition, or access and view the catalog, in a separate web page window which does not replace the content of the other web page windows and therefore does not interfere with the purchasing functions active within those other windows; that would enable the user to be able to navigate between the web page windows with a single action and without need to close existing windows or manually open new windows during the procurement process; and which system would exercise control over the client's windows so the proper content opens in the proper page without user intervention.

### SUMMARY OF THE INVENTION

The following definitions apply to terms used throughout this document:

Action, Single Action—An unique operation which, independently of any other operation, effects a change in the state of the client or the client's browser, or which submits a request to the server, or either or both of the above. The operation may be initiated by an input from the user, or performed by the browser or the client in response to an input from the user or from the server. Although a single action may be preceded by multiple physical movements of the purchaser (e.g., moving a mouse so that a mouse pointer is over a button), the single action generally refers to a single event transmitted by a client system that indicates the submittal of a request to the server, such as the clicking of a button icon on the client system's browser display. A double-click action of the mouse may be considered as a single action if it is meant to effect a single change of state through operation of a single link, button, or linked graphic. The terms Action and Single Action are used interchangeably in the descriptions of the present invention.

Active window—The web browser window that was affected by the user's last action and that would, unless the user selects another window, be affected by the user's next action.

Button—Graphical image, generally suggestive of a rectangular button, created by the browser's program upon interpretation of commands contained within a web page received by the browser from the server, that when clicked by the user causes the browser to initiate an action.

DBMS—Database Management System—A software program which stores data, and processes requests for storage, retrieval, additions to, changes to, replacement of, and/or deletion of data.

Focus—Action caused by the browser upon interpretation of commands contained within a web page received by the browser from the server, which causes the active browser window to be displayed in front of any other open browser windows.

Linked graphic—Graphical image with which is associated a command and which, when clicked by the user, causes the browser to initiate an action.

Named window—A general designation for any of the four functional and distinct windows in the present invention: “product window,” “information window,” “catalog window,” and “order window.”

The present invention addresses the inefficiencies routinely encountered in prior art electronic commerce systems for the purchase of industrial and commercial supplies particularly, and in electronic commerce systems in general.

It is an object of this invention to provide an electronic commerce method and system which allows the user to more efficiently perform four basic functions performed repeatedly and iteratively in purchasing products: find products, select products for purchase, obtain product information, and create purchase orders for products; and to provide functionality to manage content within four corresponding and distinct web page windows: “catalog window,” “product window,” “information window,” and “order window,” all within an intranet or the Internet.

It is a further object of this invention to provide the capability to display additional information which the user may wish to view about a product, within a separate web page window which does not replace the content of the other web page windows and therefore does not interfere with the purchasing functions active within those windows.

It is a further object of this invention to provide functionality within said electronic commerce system to identify web page windows uniquely by name and associate web page output with a particular named window.

It is a further object of this invention to provide functionality within said electronic commerce system to provide control of which named window the server output is displayed in, to maintain method integrity.

It is a further object of this invention to provide functionality within each window display in said electronic commerce system to enable the user to access with a single action any one of the named windows in which the various system purchasing functions are displayed.

It is a further object of this invention to provide functionality within each web page that contains navigation controls that said navigation controls provide focus capability for the active window.

It is a further object of this invention to provide a catalog within said electronic commerce system which enables the user to search through a comprehensive number of categories arranged in hierarchical form within a single web page and without need for scrolling, and which catalog additionally allows the user to select and cause to display in a single action a product selection page containing the desired items.

It is a further object of this invention to provide a keyword-based search function within said electronic commerce system to enable the user to search the entire database to locate product selection pages by using commodity specific keywords, aliases and abbreviations, and which search functionality additionally allows the user to select a category hypertext link from the search results page and cause to display in a single action a product selection page containing the desired items.

It is a further object of this invention to provide a plurality of product selection pages, and be able to enter the desired quantities of each product, and to be able to submit the selected products to the server for purchase with a single action.

In a preferred embodiment, the user, while within the “product window”, with a single action requests a “catalog web page” from the server using the client's web browser software. The server retrieves and transmits a “catalog web page” to the client which displays it in a single web browser window, the “catalog window”. The user selects a catalog category requesting the server to retrieve from its database the product data associated with said category and transmit it as a “product selection web page” to the client which further causes the client's browser to open or focus (bring forward) a window, the “product window”, to display the data. The user optionally, if the users feels more information is needed to select a particular product, clicks a link requesting the server or a third party server to retrieve product information and transmit a “product information web page” to the client which further causes the client's browser to spawn a new window, the “information window”, to display the information. Within the “product window”, the user optionally uses the search function within the “product information web page” to find a desired catalog category within the search results which are displayed in the “search results web page” within the “product window”, which desired catalog category can be selected causing the resulting “product information web page” to be displayed in the “product window”. Within the “product window”, the user optionally can with a single action transmit a request to the server to view the stored requisition which causes the client's browser to spawn a new window, the “order window”, or to focus the “order window” if already open, to display the “requisition web page”. The user selects any products desired from the products displayed within the “product window” and enters the quantities desired to be purchased of each product, and with a single action clicks on a link requesting the server to initiate processing of the selected items as a requisition and transmit the requisition data to the client which further causes the client to spawn a new window, the “order window”, or to focus the “order window” if already open, to display the “requisition web page” with the selected items included. The user can return to the “catalog window” or the “product window” with a single action to add more items to the requisition. When product selection is complete, the user clicks on a link within the “requisition web page” requesting the server to process the requisition into a purchase order and transmit the purchase order data to the client which causes the client to display the “purchase order receipt web page” in the existing “order window.” The user can return to the “catalog window” or the “product window” with a single action if further shopping is desired.

The functionality potential and advantages of the invention should be apparent from the above, the accompanying drawings, and the spirit and scope of the appended claims, when compared to the shortcomings of the prior art as detailed elsewhere within the present text and to anyone skilled in the art.

### BRIEF DESCRIPTION OF THE DRAWINGS

FIG. 1 is a block diagram of an embodiment of an electronic commerce purchasing system in accordance with the present invention.

FIG. 2 is a flow diagram of an electronic commerce purchasing method and system in accordance with the present invention.

FIG. 3A is a flow diagram illustrating steps related to system start, the opening and use of the catalog window, and the opening of the product selection page within the product window, in a preferred embodiment of the present invention.

FIG. 3B is a flow diagram illustrating steps related to the functionality of the search function in a preferred embodiment of the present invention.

FIG. 3C is a flow diagram illustrating steps related to the opening of the information window and the functionality of an information web page in a preferred embodiment of the present invention.

FIG. 3D is a flow diagram illustrating steps related to the opening of the order window and the functionality of a requisition web page in a preferred embodiment of the present invention.

FIG. 3E is a flow diagram illustrating steps related to the functionality of a shipping web page, a payment web page, and an order receipt web page, all within the order window, in a preferred embodiment of the present invention.

FIG. 4 is a flow diagram illustrating the navigation interactions between the four system windows in one embodiment of the present invention.

FIG. 5A is a flow diagram illustrating steps related to the navigation functionalities of the product window when in product selection web page mode, and the navigation functionalities of the information window in one embodiment of the present invention.

FIG. 5B is a flow diagram illustrating steps related to the navigation functionalities of the product window when the search function is in use in one embodiment of the present invention.

FIG. 5C is a flow diagram illustrating steps related to the navigation functionalities of the order window in one embodiment of the present invention.

FIG. 5D is a flow diagram illustrating steps related to the navigation functionalities of the catalog window in one embodiment of the present invention.

FIG. 6 is a view of a hierarchical arrangement type catalog web page as displayed within the catalog window in a user's web browser in one embodiment of the present invention.

FIG. 7 is a view of a hierarchical arrangement type catalog web page as displayed within the catalog window in a user's web browser in another embodiment of the present invention.

FIG. 8 is a view of the product selection web page as displayed within the product window in a user's web browser in one embodiment of the present invention.

FIG. 9 is a view of the search results web page as displayed within the product window in a user's web browser in one embodiment of the present invention.

FIG. 10 is a view of the requisition web page as displayed within the order window in a user's web browser in one embodiment of the present invention.

FIG. 11 is a view of the order receipt web page as displayed within the order window in a user's web browser in one embodiment of the present invention.

### DETAILED DESCRIPTION OF THE INVENTION

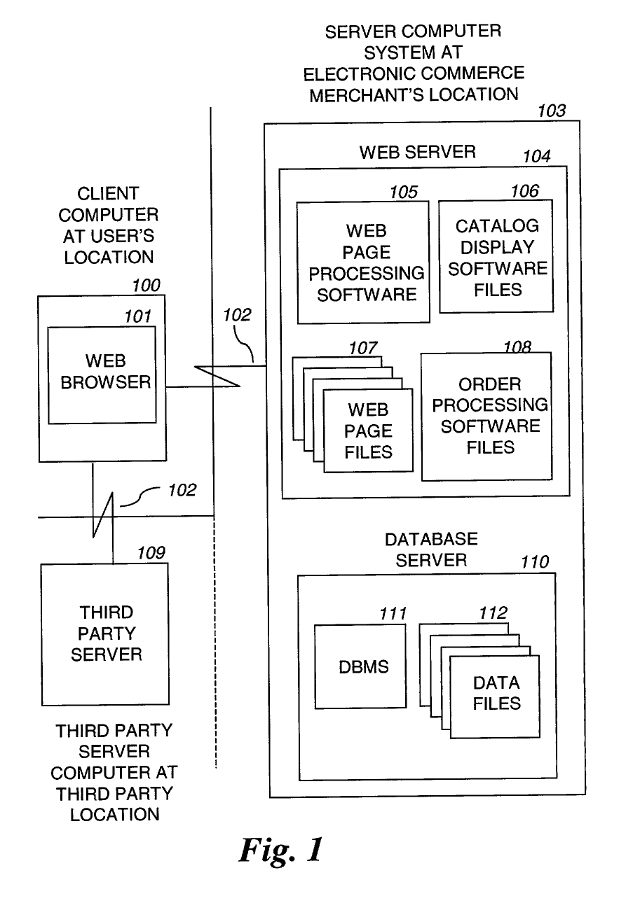

FIG. 1 shows a block diagram of an electronic commerce purchasing system in accordance with the present invention. In FIG. 1 numeral 100 denotes a client computer (referred to as “the client” in subsequent Figures) at a user's location. It is possible in accordance with the invention to have a plurality of users and client computers at each user location, and each user may operate one or more client computers. Numeral 101 denotes a web browser software application (referred to as “the browser” in subsequent Figures) operating in the client computer. Numeral 102 denotes a connection between the client computer and a server system. The connection may be made via the Internet or via the user's intranet. Numeral 103 denotes the electronic commerce merchant's server computer system (referred to as “the server” in subsequent Figures). Numeral 104 denotes a web server computer, at the electronic commerce merchant's location, which processes the web pages and transmits them to the client computer 100. The client's web browser software 101 interprets the markup language output of the web server 104. Numeral 105 denotes the web page processing software resident in memory within the web server. Numeral 106 denotes the catalog display software files resident in memory within the web server. Numeral 107 denotes a plurality of web page files resident in memory within the web server. Numeral 108 denotes the order processing software files resident in memory within the web server. Numeral 110 denotes a database server computer, at the electronic commerce merchant's location, which contains a database management system 111 (referred to as “the DBMS” in subsequent Figures) that processes the data contained in the data files 112. Numeral 109 denotes a third party server computer (referred to as “a third party server” in subsequent Figures) at a location remote from the user or the merchant.

The web server 104 receives a user-generated request from the web browser 101 to access a particular web page such as a product selection page. The web page processing software 105 processes the request. If the request requires data input, the web page processing software 105 transmits a request to the server 103 to retrieve data from the database server 110. The DBMS 111 processes the request for data, retrieves the necessary data from the data files 112, and transmits the data to the web server 104. The web page processing software 105 accesses a web page file 107. If data is required by the web page file, the web page processing software 105 incorporates the data into the web page file 107. The web page processing software 105 transmits the web page to the client computer 100 and the client's web browser 101 displays the web page.

The web server 104 may optionally receive a user-generated request from the web browser 101 to access another web page such as a catalog page. The web page processing software 105 processes the request. The web page processing software 105 accesses the catalog display software files 106. The web page processing software 105 transmits the catalog page to the client computer 100 and the client's web browser 101 displays the catalog page.

The web server 104 may optionally receive a user-generated request from the web browser 101 to access another web page such as the requisition page. The web page processing software 105 processes the request. The web page processing software 105 accesses the order processing software files 108. The web page processing software 105 transmits the requisition page to the client computer 100 and the client's web browser 101 displays the requisition page.

A particular web page file 107 may contain links to third party web pages. The user may select such a link within a web page displayed in the client's web browser 101 and cause the client's web browser 101 to access a web page at a third party website. The client's web browser 101 transmits a request to the third party's website computer 109 via the Internet connection 102. The third party's website computer 109 transmits the desired third party web page to the client computer 100 and the client's web browser 101 displays the desired third party web page.

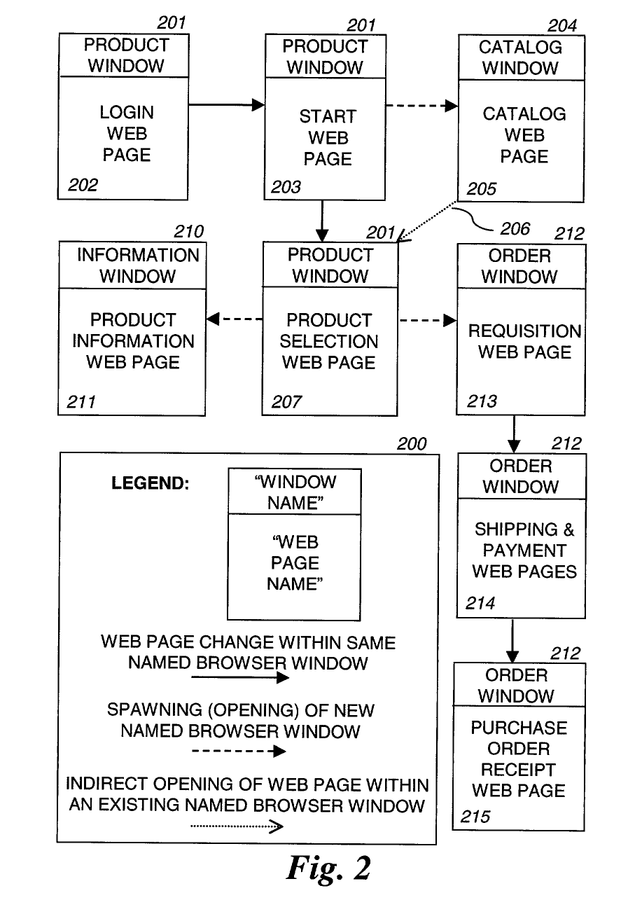

FIG. 2 shows a flow diagram of an electronic commerce purchasing method and system in accordance with the present invention. The legend 200 shows the functional significance that is assigned to each of the types of arrows that connect the various window diagrams, as relates to the method of the present invention. Legend 200 also shows how the window names and web page names that are components of the method of the present invention are pictorially represented in each window diagram.

Upon an initial user-generated request by the client to access the server, the server causes the client's browser to designate and recognize the open browser window as the “product window” and causes the browser to display a login web page 202 within product window 201. When the user submits the correct login information, the server transmits a start web page 203 and causes the start web page 203 to be displayed in product window 201. The end user initiates a request within the start web page 203 which causes the server to transmit the catalog page data to the client and causes the browser to spawn a new window which is designated and recognized by the browser as the “catalog window” denoted as catalog window 204, and to display the catalog web page 205 within catalog window 204. The user selects a category within the catalog web page 205 which causes the server to transmit a product selection page file to the browser and causes an indirect action 206 which causes the browser to display a product selection web page 207 in the product window 201. The user may select a link within the product selection web page 207 which transmits a request to the server or to a third party server, which causes the browser to spawn a new window which is specially designated and recognized by the browser as the “information window” and is denoted as information window 210, and to display an information web page 211 within information window 210. The user may select one or more products from the product selection web page 207 and submit a request to the server to enter the selected products as items into an electronic requisition. The server processes the request and transmits the requisition data to the client, which causes the browser to spawn a new window which is specially designated, and recognized by the browser as the “order window” and is denoted as order window 212, and to display the requisition web page 213 within order window 212. The user may submit a request to the server to convert the requisition into a purchase order. The server processes the request and transmits purchase order data to the client, which causes the browser to display the shipping and payment info web pages 214 in order window 212. To complete the purchase order process, the user submits a request to the server to process the shipping and payment data and finalize the purchase order. The server processes the request and transmits the purchase order receipt data to the client, which causes the browser to display the purchase order receipt web page 215 in order window 212.

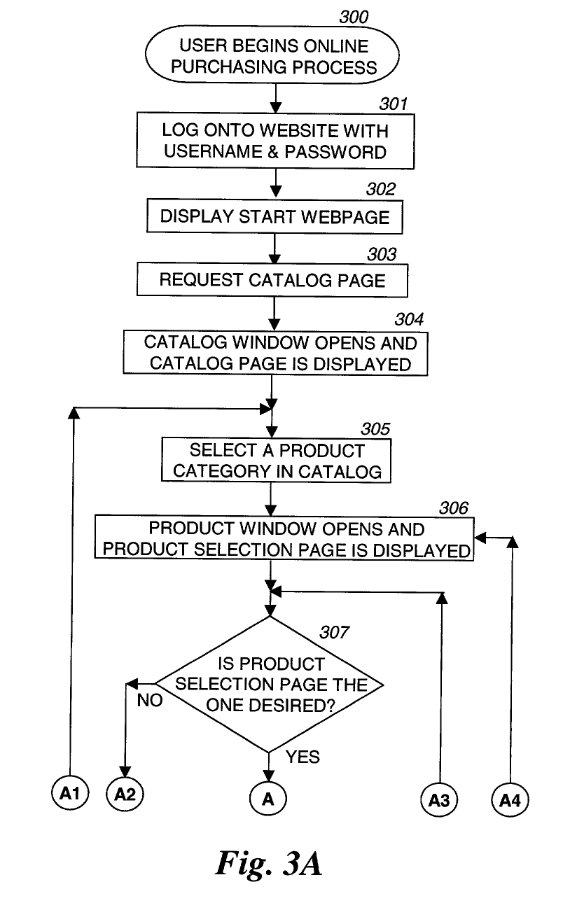

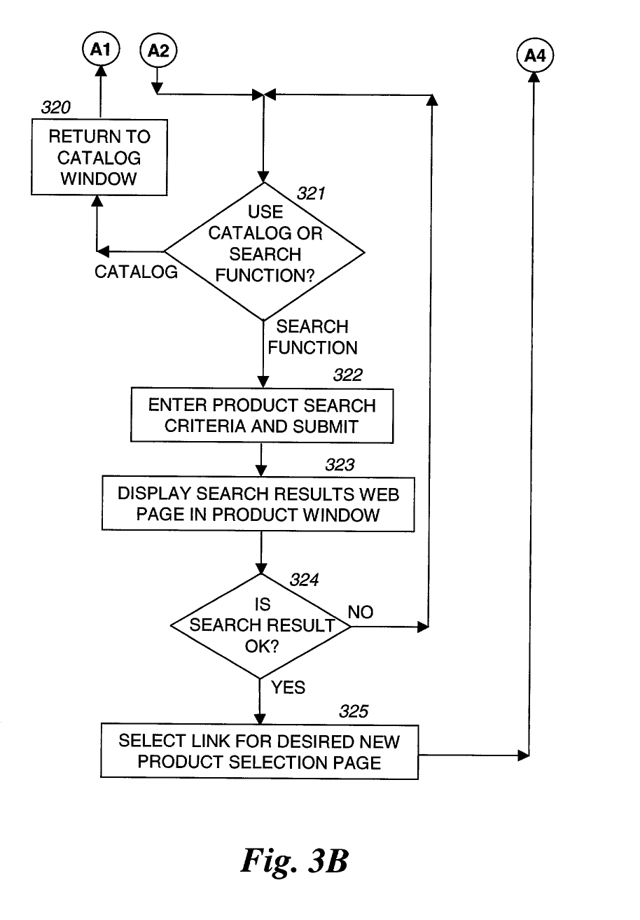

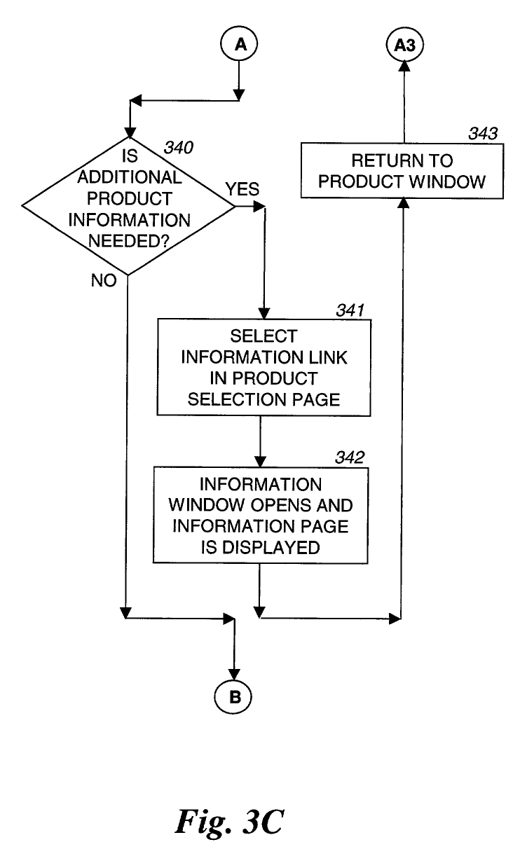

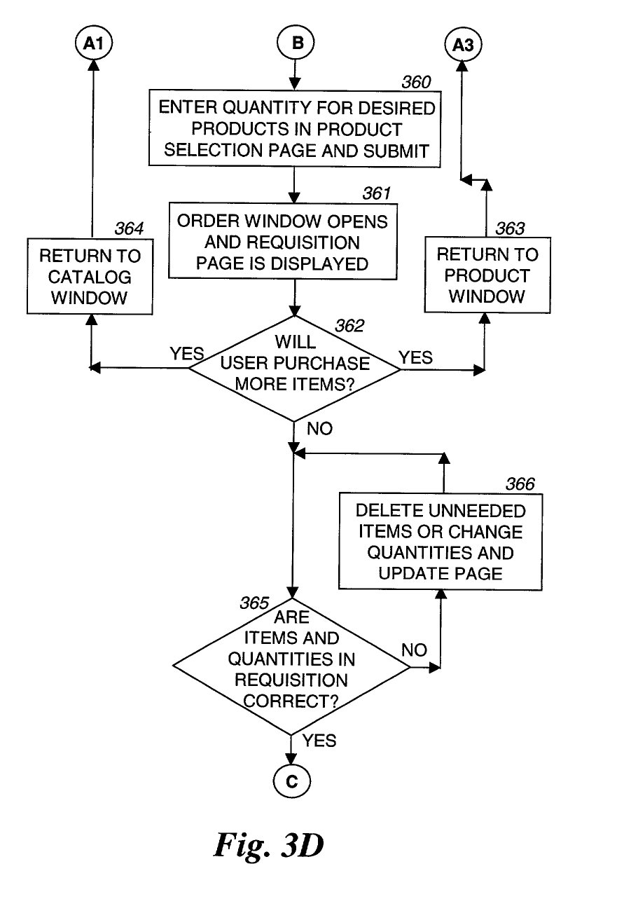

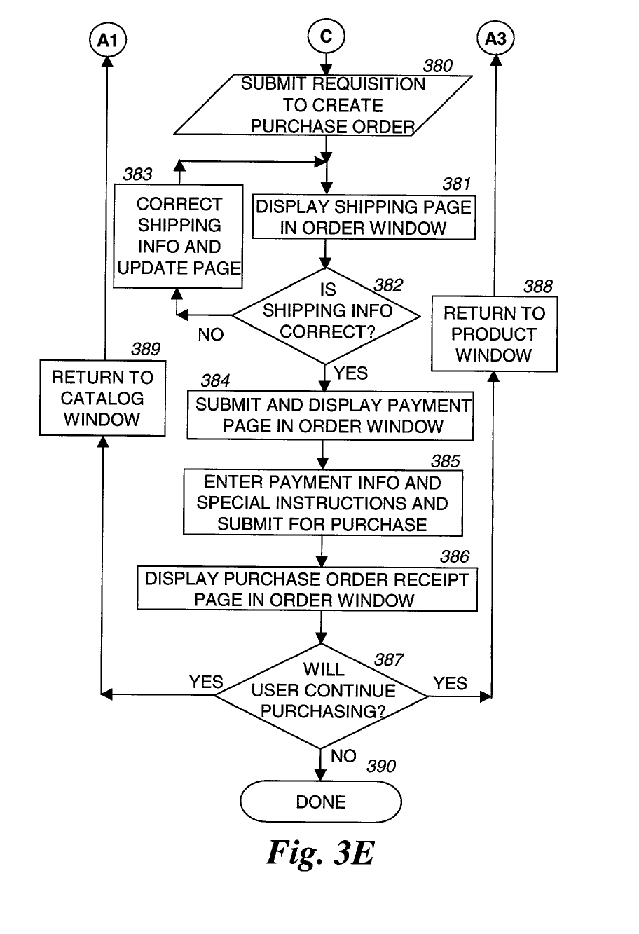

FIGS. 3A through 3E show flow diagrams illustrating overall method and system functionalities, and interrelationships between the system windows and various web pages in a preferred embodiment of the invention. In FIG. 3A, step 300, the user begins the online purchasing process by entering into the browser the online address for the electronic commerce merchant's website. In step 301, the user logs onto the website by submitting a username and password to the server. In step 302, the server transmits data to the client and causes the browser to display a start web page in the active window which becomes the product window. In step 303, the user submits a request for a catalog page to the server. In step 304, the server transmits the catalog page data to the client and causes the browser to spawn a new browser window which becomes the catalog window, and further causes the browser to display the catalog web page within the catalog window. In step 305, the user selects a product category link within the catalog web page, which action creates a request by the client to the server for a product selection page. In step 306, the server retrieves the product data from the DBMS and transmits it to the client and causes the browser to display the product selection page within the product window. In step 307, the user determines if the product selection web page that was retrieved from the server is the one that the user desired.

If the product selection web page is not the one desired, then in FIG. 3B, step 321, the user determines if the catalog or the search engine will be used to locate another product or product selection page. If the catalog is to be used, then in step 320, the user will select a link that will cause a return to the catalog window, and the action will cause the browser to make the catalog window the active window and focus it to allow the user to continue the purchasing process from step 305. If in step 321 the user elects to use the search engine, then in step 322, the user enters the desired product search terms in the appropriate text entry blanks and submits to the server. In step 323, the server processes the search request, retrieves the product data from the DBMS and transmits it to the client and causes the browser to display the search results in the product window. In step 324, if the user determines that the search result provided the link to the desired product selection page for the desired product, then in step 325, the user selects the link for the desired product selection page and the server retrieves the product data from the DBMS and transmits it to the client and causes the browser to display the product selection page within the product window, allowing the user to continue the purchasing process continuing from step 307. If in step 324 the user determines that the search result was inadequate, then the user would return to step 321 to determine if the catalog will be used or if a new search 322 will be initiated.

If in step 307 the user determines that the product selection web page is the one desired, then in FIG. 3C, step 340, the user determines if any additional product information is needed. If additional information is needed, then in step 341, the user selects a link for the desired information web page which causes the client to submit a request to the server or to a third party server for the desired information web page. In step 342, the server or third party server transmits the information web page file to the client which causes the browser to spawn a new browser window which becomes the information window, and further causes the browser to display the information web page within the information window. In step 343, the user determines that the information web page is no longer needed and selects a link that will cause a return to the product window, and the action will cause the browser to make the product window the active window and focus it to allow the user to continue the purchasing process from step 307.

If in step 340 the user determines that additional information is not needed, then in FIG. 3D, step 360, the user selects a product from the product selection page by entering the quantity desired for purchase and submits a request to the server to process the selection. In step 361, the server transmits the product data to the client, and causes the browser to spawn a new window, which becomes the order window, and display the requisition web page within the order window. If in step 362 the user determines that more items are needed for purchase, then in step 363, the user will select a link that will cause a return to the product window; or, in step 364, the user will select a link that will cause a return to the catalog window, and, in either case, the action will cause the browser to make that window the active window and focus it to allow the user to continue the purchasing process from step 307 or step 305, respectively. If no more items are needed for purchase, then in step 365, the user inspects the contents of the requisition web page to verify item quantities and that it contains the desired items. If the items or quantities are incorrect, in step 366, the user submits a request to the server to delete any unneeded items or correct any quantities. The server transmits the corrected data to the client which causes the browser to display the updated requisition in the order window.

If in step 365 the user determines that the information in the requisition is correct, then in FIG. 3E, step 380, the user submits a request to the server to create a purchase order. The server processes the purchase order request and transmits the purchase order data to the client which, in step 381, causes the browser to display the shipping information web page in the order window. In step 382, the user determines if the information in the shipping web page is correct. If the shipping information is incorrect, then in step 383, the user submits a request to the server to correct the shipping information. The server transmits the corrected data to the client, which causes the browser to display the updated shipping web page in the order window. If the shipping information is correct, then in step 384, the user submits a request to the server to process the shipping information. The server processes the shipping information and transmits the payment web page data to the client, which causes the browser to display the payment web page in the order window. In step 385, the user submits the payment information and submits the order to the server for final processing. In step 386, the server processes the payment information and transmits the purchase order receipt data to the client which causes the browser to display the purchase order receipt web page in the order window. If in step 387 the user determines that more items are needed for purchase, then in step 388, the user will select a link or click on a button that will cause a return to the product window; or, in step 389, the user will select a link that will cause a return to the catalog window, and, in either case, the action will cause the browser to make that window the active window and focus it to allow the user to continue the purchasing process from step 307 or step 305, respectively. In step 390, if the user determines that further purchasing activity is not required, the user will discontinue the purchasing process. At this step the user may close any or all the browser windows, or leave them open for resumption of purchasing activity at a later time.

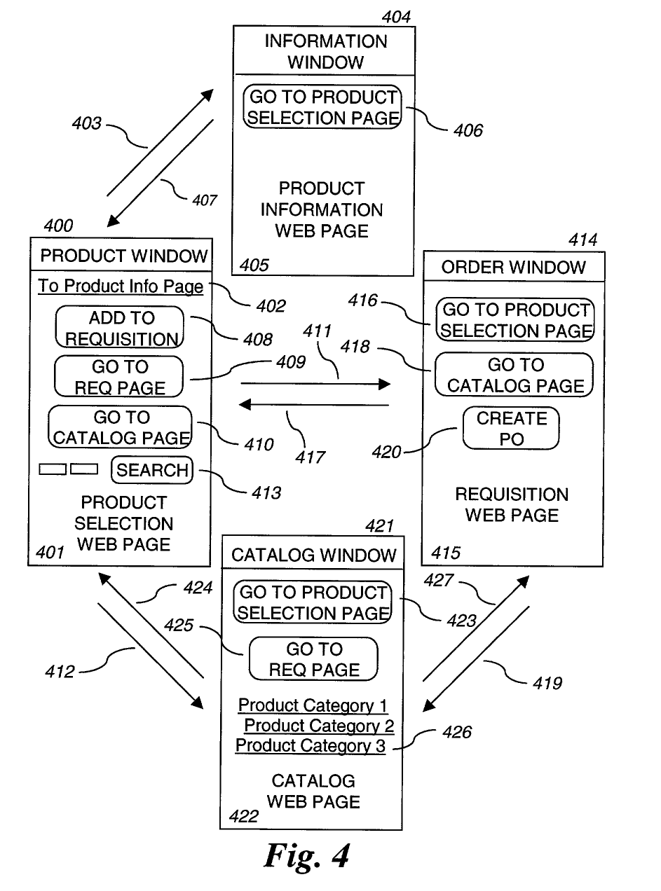

FIG. 4 is a flow diagram illustrating the navigation interactions between the four system windows in one embodiment of the present invention. Numeral 400 is a representation of the browser display of the product window. Numeral 401 denotes a product selection web page that is displayed in the product window 400. Numeral 404 is a representation of the browser display of the information window. Numeral 405 denotes the product information web page that is displayed in the information window 404. Numeral 414 is a representation of the browser display of the order window. Numeral 415 denotes a requisition web page that is displayed in the order window 414. Numeral 421 is a representation of the browser display of the catalog window. Numeral 422 denotes the catalog web page that is displayed in the catalog window 421. The system and method of the present invention make it possible for the user to navigate from one system window to another. The system and method is designed so that it is not necessary to follow a prescribed order or navigation sequence to switch from one window to another. Navigation, or switching, between any of the four system windows is effected through clicking on a link which may consist of a button, a hypertext link, or a linked graphic.

If the user is viewing a product selection web page in the product window, the user can select a product information web page link 402 which causes the browser to transmit a request for a web page to the server or to a third party server computer. The browser processes a command 403 which causes the spawning and/or focus of the information window 404 and the display of a product information web page 405 in the information window 404. If at any time while on the information window the user wishes to go to the product window, the user clicks on the go-to-product-selection-page link 406 in the product information web page 405, which causes the browser process a command 407 to focus the product window 400.

If at any time while on the product window the user wishes to view the contents of the requisition without adding products to it, the user can click on the go-to-requisition-page button 409 which causes the browser to process a command 411 to spawn and/or focus the order window 414 and display the requisition web page 415 within the order window 414. If at any time while on the product window the user wishes to go to the catalog window, the user can click on the go-to-catalog-page button 410, which causes the browser to process a command 412 to spawn and/or focus the catalog window 421 and display a catalog web page 422 within the catalog window 421.

If at any time while on the product window the user wishes to use the search function, the user enters the desired product search terms in the appropriate text entry blanks and submits to the server by clicking on the search link 413.

If the user has selected products for purchase in the product selection web page 401, the user clicks the add-to-requisition button 408 which causes the browser to submit a request 411 to the server to add the selected products to the requisition and causes the server to transmit the requisition data to the client which causes the client's browser to spawn and/or focus the order window 414 and display the requisition web page 415 in the order window 414. If the user is viewing a requisition web page in the order window 414 and the user has finished selecting products and desires to convert the requisition into a purchase order, the user clicks the create-purchase-order button 420 in the requisition web page which causes the browser to submit a request to the server to process the requisition into a purchase order.

If at any time while on the order window 414 the user wishes to go to the product window 400, the user can click on the go-to-product-selection-page button 416 which causes the browser to process a command 417 to focus the product window 400. If at any time while on the order window 414 the user wishes to go to the catalog window 421, the user can click on the go-to-catalog-page button 418 which causes the browser to process a command 419 to focus the catalog window 421 and display a catalog web page 422 in the catalog window 421.

In the catalog web page 422, the user can click on a product category link 426 which causes the browser to transmit a request to the server for a product category web page and to process a command 424 causes the browser to focus the product window 400 and display a product category web page 401 within the product window 400.

If at any time while on the catalog window 421 the user wishes to go to the product window 400, the user can click on the go-to-product-selection-page button 423 which causes the browser to process a command 424 to focus the product window 400. If at any time while on the catalog window 421 the user wishes to view the requisition, the user can click on the go-to-requisition-page button 425 which causes the browser to process a command 427 to focus the order window 414 and display the requisition web page 415 in the order window 414.

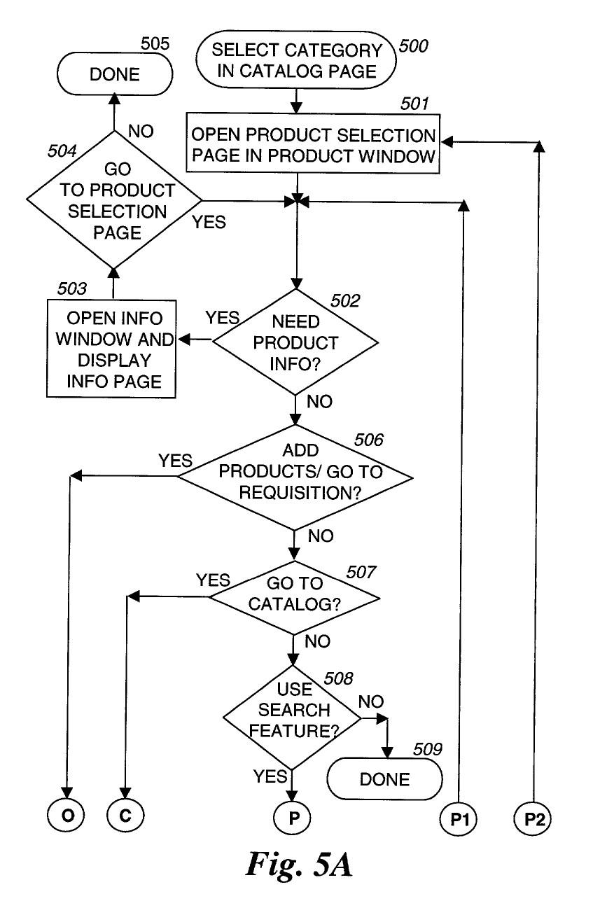

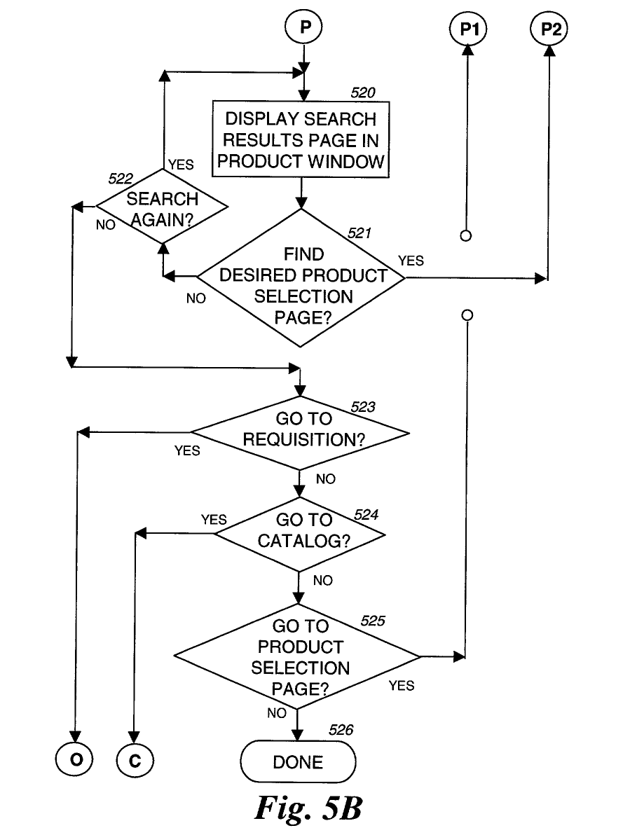

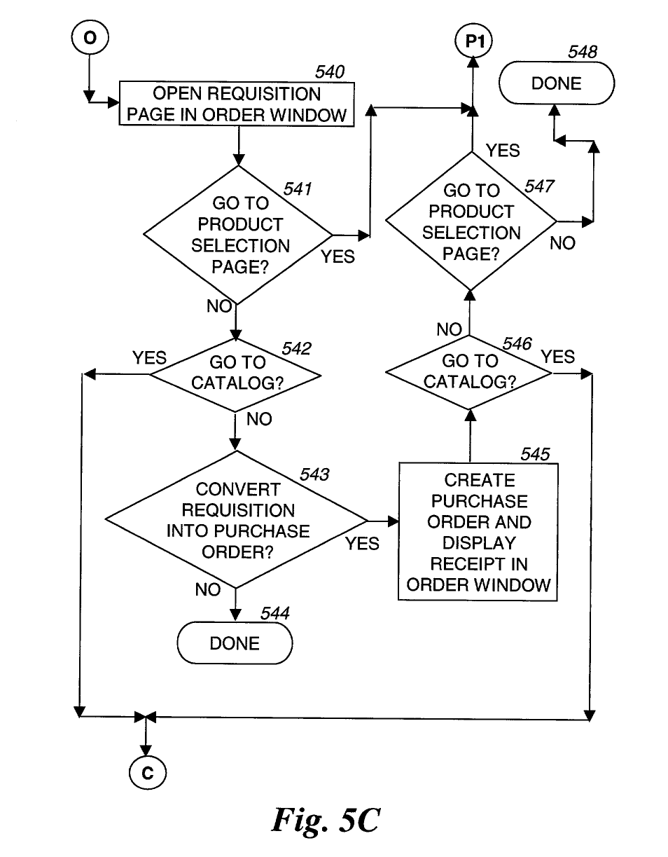

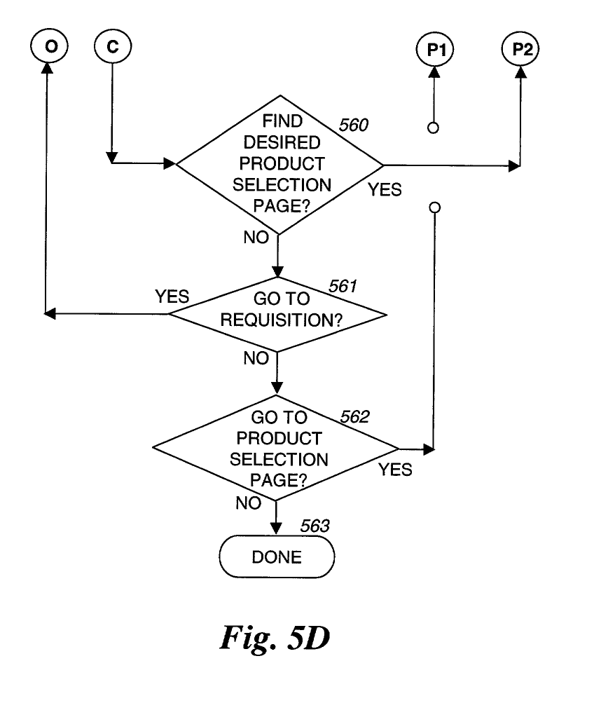

FIGS. 5A through 5D show flow diagrams illustrating the steps related to the window-to-window navigation functionalities of the method in one embodiment of the present invention. Various different actions from various types of input devices can be used to navigate from one system window to another, to effect the selection of categories from the catalog or to effect the submittal for purchase of items within a product selection web page. For example, a voice command may be spoken by the user, a key may be depressed by the user, a button on a remote control device may be depressed by the user, or selection using any pointing device may be effected by the purchaser.

In FIG. 5A, step 500, the user selects a category link within the catalog web page. In step 501, the server causes a product selection web page to be opened in the product window. In step 502, the user determines if additional product information is needed. If in step 502 the user determines that additional product information is needed, then in step 503, the user creates an action, which causes the browser to open the information window and display the requested information web page. In step 504, the user determines if the user needs to return to the product selection page to continue the purchasing process. If in step 504 the user determines to not return to the product selection page, then the user terminates the purchasing process as indicated by step 505. If in step 504 the user determines to return to the product selection web page, then the user creates an action which causes the browser to make the product window the active window and focus it to allow the user to continue the purchasing process from step 502. If in step 502 the user determines that no additional product information is needed, then in step 506 the user determines if the user needs to view/add to the requisition. If the user determines that the user needs to view/add to the requisition, the user creates an action which causes the browser to make the order window the active window and focus it to allow the user to continue the purchasing process from step 540. If the user does not need to view/add to the requisition, then in step 507 the user determines if the user needs to view the catalog. If in step 507 the user determines that the user needs to view the catalog, then the user creates an action which causes the browser to make the catalog window the active window and focus it to allow the user to continue the purchasing process from step 560. If the user does not need to view the catalog, then in step 508 the user determines if the user needs to use the system's search function. If in step 508 the user determines to not use the system's search function, then the user terminates the purchasing process as indicated by step 509.

If in step 508 the user determines that the user needs to use the system's search function, then in FIG. 5B, in step 520, the user creates an action which causes the browser to submit a search request to the server which causes the server to display a search results web page in the product window. In step 521, the user determines if the search results contain a desired product selection web page link. If the search results do contain a desired product selection web page link, the user creates an action which causes the browser to open the desired product selection web page in the product window and allow the user to continue the purchasing process from step 501. If the search results do not contain a desired product selection web page link, then in step 522 the user determines if the user will use the search function again. If in step 522 the user determines to use the search function again, then the user creates an action that causes the browser to submit another search request to the server and allow the user to continue the purchasing process from step 520. If in step 522 the user determines not to use the search function again, then in step 523 the user determines if the user needs to view the requisition. If the user determines that the user needs to view the requisition, the user creates an action which causes the browser to make the order window the active window and focus it to allow the user to continue the purchasing process from step 540. If the user does not need to view the requisition, then in step 524 the user determines if the user needs to view the catalog. If in step 524 the user determines that the user needs to view the catalog, then the user creates an action which causes the browser to make the catalog window the active window and focus it to allow the user to continue the purchasing process from step 560. If the user does not need to view the catalog, then the user determines if the user needs to return to the product selection web page. If the user determines that the user needs to return to the product selection web page, then the user creates an action which causes the browser to make the product window the active window and focus it to allow the user to continue the purchasing process from step 502. If the user determines that the user does not need to return to the product selection web page, then the user terminates the purchasing process as indicated by step 526.

In FIG. 5C, in step 540, the user creates an action which causes the browser to make the order window the active window and focus it and display the requisition page in the order window. In step 541, the user determines if the user needs to return to the product selection web page. If the user determines that the user needs to return to the product selection web page, then the user creates an action which causes the browser to make the product window the active window and focus it to allow the user to continue the purchasing process from step 502. If the user determines that the user does not need to return to the product selection web page, then in step 542 the user determines if the user needs to view the catalog. If in step 542 the user determines that the user needs to view the catalog, then the user creates an action which causes the browser to make the catalog window the active window and focus it to allow the user to continue the purchasing process from step 560. If the user does not need to view the catalog, then the user, in step 543, determines if the user needs to convert the requisition into a purchase order. If in step 543 the user determines that the user does not need to convert the requisition into a purchase order, then the user terminates the purchasing process as indicated by step 544. If in step 543 the user determines that the user needs to convert the requisition into a purchase order, then in step 545 the user creates an action (or actions) that cause(s) the browser to submit a request to the server to process the requisition and convert it into a purchase order which causes the browser to make the order window the active window and focus it and display the purchase order receipt web page in the order window. In step 546, the user determines if the user needs to view the catalog. If in step 546 the user determines that the user needs to view the catalog, then the user creates an action which causes the browser to make the catalog window the active window and focus it to allow the user to continue the purchasing process from step 560. If the user does not need to view the catalog, then the user determines if the user needs to return to the product selection web page. If the user determines that the user needs to return to the product selection web page, then in step 547, the user creates an action which causes the browser to make the product window the active window and focus it to allow the user to continue the purchasing process from step 502. If the user determines that the user does not need to return to the product selection web page, then the user terminates the purchasing process as indicated by step 548.

In FIG. 5D, step 560, the user determines if a desired product selection web page was found in the catalog web page. If in step 560 the user determines that a desired product selection web page was found in the catalog, then the user creates an action which causes the browser to open the desired product selection web page in the product window and allow the user to continue the purchasing process from step 501. If in step 560 the user determines that no desired product selection web pages were found in the catalog, then in step 561 the user determines if the user needs to view the requisition. If the user determines that the user needs to view the requisition, the user creates an action which causes the browser to make the order window the active window and focus it to allow the user to continue the purchasing process from step 540. If the user does not need to view the requisition, then in step 562, the user determines if the user needs to return to the product selection web page. If the user determines that the user needs to return to the product selection web page, then the user creates an action which causes the browser to make the product window the active window and focus it to allow the user to continue the purchasing process from step 502. If the user determines that the user does not need to return to the product selection web page, then the user terminates the purchasing process as indicated by step 563.

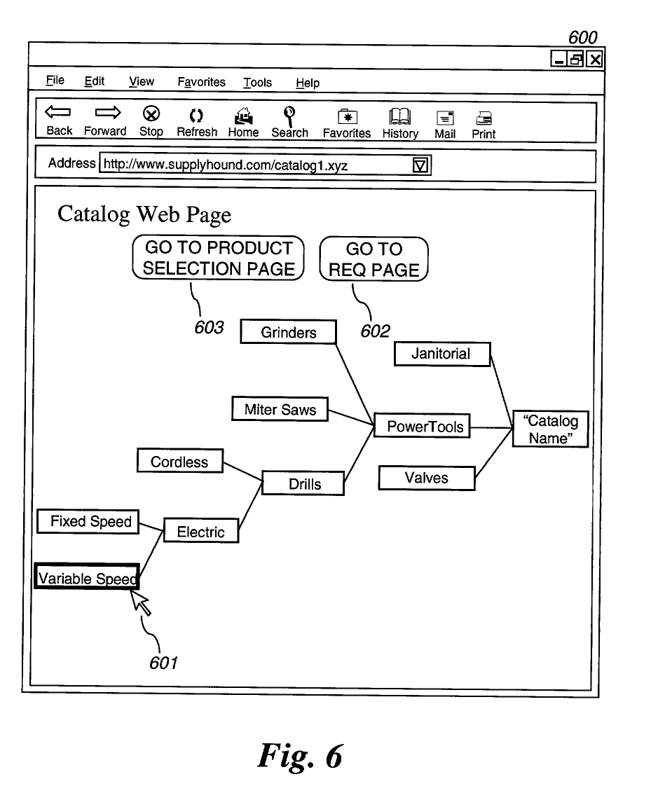

FIG. 6 is a view of a hierarchical arrangement type catalog web page as displayed within the catalog window in a user's web browser in one embodiment of the present invention. A catalog web page is displayed in the catalog window 600. The user selects a link 601 to a product selection web page from within the catalog which creates an action that causes the server to submit a request to the server and causes the server to transmit the product selection page data to the browser which causes the browser to display the product selection web page in the product window. If the user does not need to select a catalog link, the user may click the go-to-req-page button 602 which creates an action that causes the browser to make the order window the active window and focus it and display the requisition web page in the order window. Alternatively, the user may click the go-to-product-selection-page button 603 which creates an action that causes the browser to make the product window the active window and focus it to allow the user to select products from the current product selection page or to use the search function.

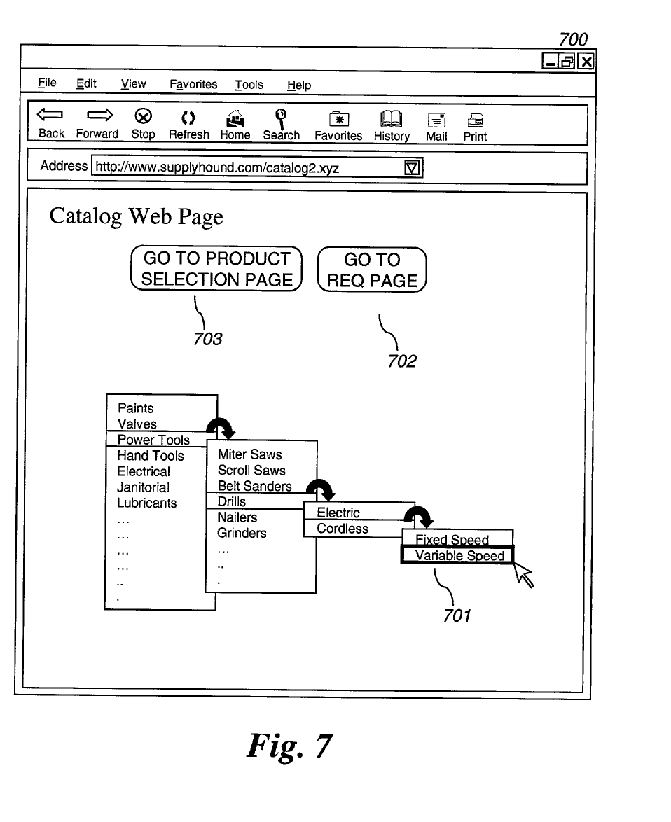

FIG. 7 is a view of a hierarchical arrangement type catalog web page as displayed within the catalog window in a user's web browser in another embodiment of the present invention. A catalog web page is displayed in the catalog window 700. The user selects a link 701 to a product selection web page from within the catalog which creates an action that causes the server to submit a request to the server and causes the server to transmit the product selection page data to the browser which causes the browser to display the product selection web page in the product window. If the user does not need to select a catalog link, the user may click the go-to-req-page button 702 which creates an action that causes the browser to make the order window the active window and focus it and display the requisition web page in the order window. Alternatively, the user may click the go-to-product-selection-page button 703 which creates an action that causes the browser to make the product window the active window and focus it to allow the user to select products from the current product selection page or to use the search function.

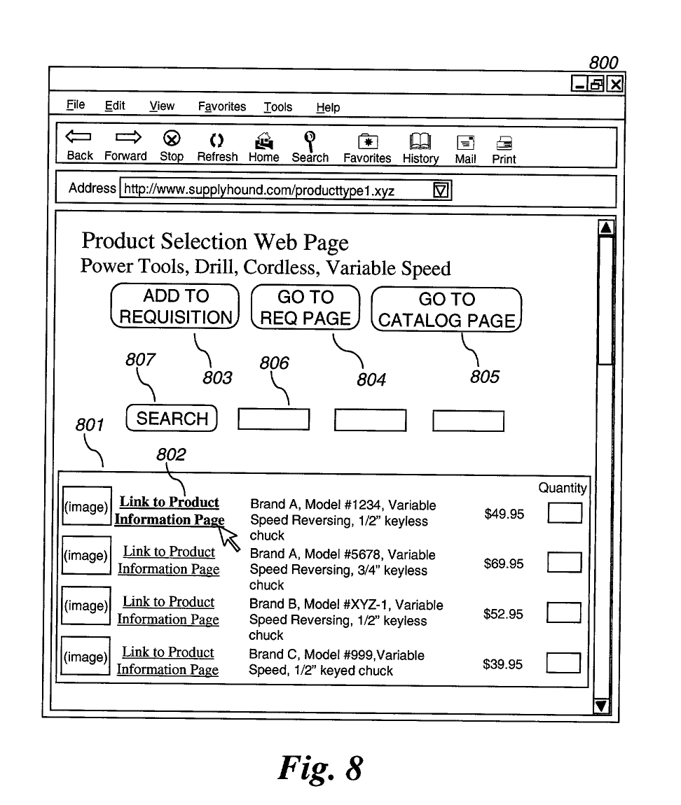

FIG. 8 is a view of the product selection web page as displayed within the product window in a user's web browser in one embodiment of the present invention. A product selection web page is displayed in the product window 800. The user inspects the products list 801 and optionally selects a link to product information page 802 which causes the browser to request from the server or from a third-party server a product information web page and causes the browser to display the information web page in the information window. Alternatively, the user may click the add-to-requisition button 803 which creates an action that causes the browser to submit a request to the server to add one or more products selected from the product selection page to the requisition, and causes the browser to make the order window the active window and focus it and display the requisition web page in the order window. Alternatively, the user may click the go-to-req-page button 804 which creates an action that causes the browser to make the order window the active window and focus it and display the requisition web page in the order window. Alternatively, the user may click the go-to-catalog-page button 805 which creates an action that causes the browser to make the catalog window the active window and focus it and display the catalog web page in the catalog window. Alternatively, the user may enter search keywords in the text boxes 806 provided, and click the search button 807 which creates an action that causes the browser to request a search from the server and causes the server to transmit the search results to the client which causes the browser to display the search results web page in the product window.

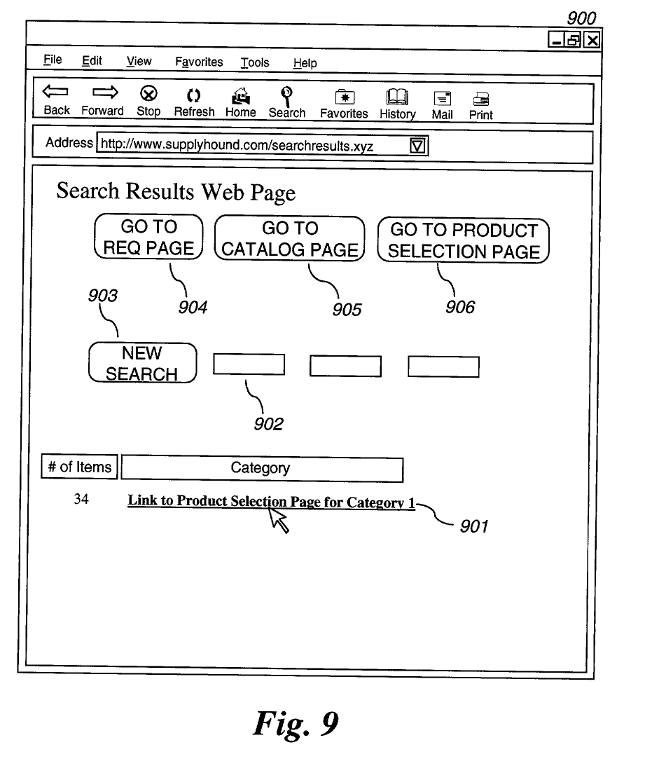

FIG. 9 is a view of the search results web page as displayed within the product window in a user's web browser in one embodiment of the present invention. A search results web page is displayed in the product window 900. The user selects a link 901 to a product selection web page from the listed search results which creates an action that causes the server to submit a request to the server and causes the server to transmit the product selection page data to the browser which causes the browser to display the product selection web page in the product window. Alternatively, the user may re-enter search keywords in the text spaces 902 provided, and click the new-search button 903 which creates an action that causes the browser to request a search from the server and causes the server to transmit the search results to the client which causes the browser to display the search results web page in the product window. Alternatively, the user may click the go-to-req-page button 904 which creates an action that causes the browser to make the order window the active window and focus it and display the requisition web page in the order window. Alternatively, the user may click the go-to-catalog-page button 905 which creates an action that causes the browser to make the catalog window the active window and focus it and display the catalog web page in the catalog window. Alternatively, the user may click the go-to-product-selection-page button 906 which creates an action that causes the browser to make the product window the active window and focus it to allow the user to select products from the current product selection page or to use the search function.

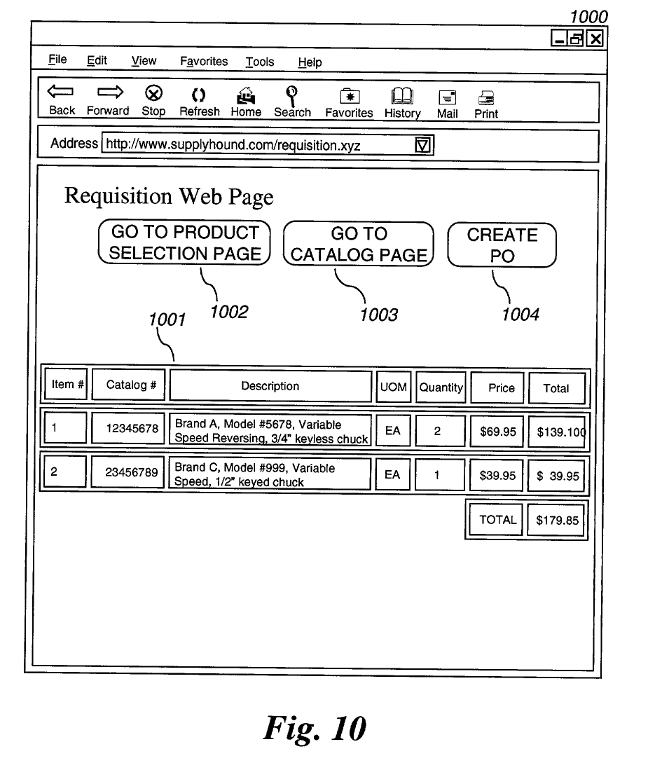

FIG. 10 is a view of the requisition web page as displayed within the order window in a user's web browser in one embodiment of the present invention. A requisition web page is displayed in the order window 1000. The user inspects the list of requisitioned items list 1001. If the user needs to continue the purchasing process, the user may click the go-to-product-selection-page button 1002 which creates an action that causes the browser to make the product window the active window and focus it to allow the user to select products from the current product selection page or to use the search function. Alternatively, the user may click the go-to-catalog-page button 1003 which creates an action that causes the browser to make the catalog window the active window and focus it and display the catalog web page in the catalog window. Alternatively, if the user determines that the requisitioned items list 1001 contains the proper items, the user may click the create-po button 1004 which creates an action that causes the browser to submit a request to the server to convert the requisition into a purchase order.

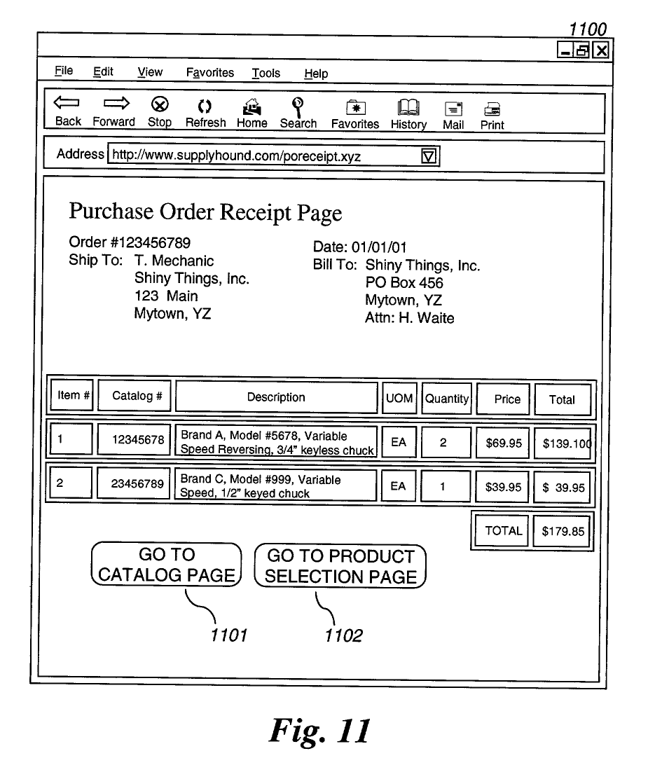

FIG. 11 is a view of the order receipt web page as displayed within the order window in a user's web browser in one embodiment of the present invention. A purchase order receipt web page is displayed in the product window 1100. The purchase order receipt web page represents the completion of a cycle of the purchasing process. If the user wishes to initiate another cycle of the purchasing process, the user clicks the go-to-catalog-page button 1101 which creates an action that causes the browser to make the catalog window the active window and focus it and display the catalog web page in the catalog window. Alternatively, the user may click the go-to-product-selection-page button 1102 which creates an action that causes the browser to make the product window the active window and focus it to allow the user to select products from the current product selection page or to use the search function.

The present invention has been described in terms of various embodiments, and it is not intended that the invention be limited to these embodiments. Modification within the spirit of the invention will be apparent to those skilled in the art. For example, the system can incorporate lists of frequently purchased items that the user has saved as personalized pages and which can be retrieved from the database and displayed and manipulated as product selection pages; or the system can interface with a separate email server for processing email notifications of orders to users and suppliers; or the system can interface with a separate communications server to convert the system's outputs and inputs into code recognizable by users' or suppliers' existing legacy systems; or the system can interface with a supplier's inventory system and incorporate into the system the display of real-time inventory data from the supplier's warehouse.

Although the foregoing invention has been described in some detail by way of illustration and example for purposes of clarity and understanding, it may be readily apparent to those of ordinary skill in the art from the details of this invention that certain changes and modifications may be made thereto without departing from the spirit or scope of the appended claims.

What is claimed is:

1. An online electronic commerce method and system for selecting products and creating purchase orders said system consisting of
(a) a web server computer running a web page processing software such as Microsoft Internet Information Server.TM or similar; said web server also running an online order processing software such as Macromedia UltraDev.TM, Microsoft.TM Site Server Commerce Edition or similar, with functionality commonly referred to as a “virtual shopping cart”; said server also storing a plurality of web page software files; said server also storing a plurality of catalog display software files;
(e) a database server running a database management system (DBMS) software such as Microsoft SQL Server.TM., Oracle.TM, Informix.TM, or similar;
(f) at least one client computer running a desktop computer operating system such as Microsoft Windows 98.TM, Windows NT.TM, Windows 2000.TM, MacOS.TM, Linux, Linux variant, or similar, and which said client computer further has installed within it a web browser software, such as Netscape Navigator.TM, Microsoft Internet Explorer.TM, Opera Software Opera.TM or similar;
said method consisting of
(a) enabling the creation and operation of four separate and distinct web browser windows: “catalog window,” “product window,” “information window,” and “order window”;
(b) enabling the web browser windows to remain open concurrently to enable the user to perform any of four basic purchasing functions: find products, select products for purchase, obtain product information, and create purchase orders for products;
(c) enabling navigation between windows to enable the user to perform any of several purchasing activities: access a product catalog, select a product category, display a product selection page, display additional product information, select a plurality of items for purchase in a single action, create a requisition, and convert a requisition into a purchase order.

2. The electronic commerce system in claim 1 wherein the web page processing software processes the requests for product data through use of the DBMS software and formats said product data in markup language format, such as Hypertext Markup Language (HTML) or Extensible Markup Language (XML) or variant such as ebXML or cXML.

3. The electronic commerce system in claim 1 wherein the catalog display software produces a hyperbolic tree display.

4. The electronic commerce system in claim 1 wherein the order processing software creates the requisitions and processes the requisitions into purchase orders.

5. The electronic commerce system in claim 1 wherein a user may be an individual with access to one or more client computers.

6. The electronic commerce system in claim 1 wherein a user location may have a plurality of users.

7. The electronic commerce system in claim 1 wherein the web server system may consist of one or more server computers.

8. The electronic commerce system in claim 1 wherein the database server may consist of one or more database server computers.

9. The electronic commerce system in claim 1 wherein the connection between the client computer and the electronic commerce system may be via hard wire or wireless.

10. The electronic commerce system in claim 1 wherein the web page software files are in HTML or XML language or a variant of HTML or XML.

11. The electronic commerce system in claim 1 wherein the web page software files may contain client-side executable script elements or applets such as Javascript or Microsoft.TM JScript.

12. The electronic commerce system in claim 1 wherein a link may be a graphical button, a hypertext link, or a linked graphic.

13. The electronic commerce system in claim 1 wherein the element that represents the command that causes a browser action or causes the browser to transmit a request to the server can interchangeably be a graphical button, a hypertext link, or an image.

14. The method in claim 1 wherein four separate and distinct web browser windows, named “Catalog Window,” “Product Window,” “Information Window,” and “Order Window,” display the data that provides functionality for the four correspondingly named basic purchasing functions performed repeatedly and iteratively in purchasing products, namely, perusing a catalog, selecting a product, obtaining additional information about a product, and placing an order for a product.

15. The method in claim 1 wherein the web page output from the web server is directed to be displayed within a particular named window.

16. The method in claim 1 wherein a separate and distinct browser window at the client computer functions as the “Catalog Window” to which the Catalog Page web page output is directed.

17. The method in claim 1 wherein a separate and distinct browser window at the client computer functions as the “Product Selection Window” to which the Product Selection Page web page output is directed.

18. The method in claim 1 wherein a separate and distinct browser window at the client computer functions as the “Information Window” to which the Information Page web page output is directed.

19. The method in claim 1 wherein a separate and distinct browser window at the client computer functions as the “Order Window” to which the Requisition Page web page output is directed.

20. The electronic commerce system in claim 1 wherein the user action which enables navigation between windows and focusing of a particular named window can be effected by a single action of the user consisting of clicking on a graphical button.

21. The electronic commerce system in claim 1 wherein the user action which enables navigation between windows and focusing of a particular named window can be effected by a single action of the user consisting of clicking on a hypertext link.

22. The electronic commerce system in claim 1 wherein the user action which enables navigation between windows and focusing of a particular named window can be effected by a single action of the user consisting of clicking anywhere within the visible portion of the desired underlying named window while another window is still in focus.

23. The electronic commerce system in claim 1 wherein the user action which enables navigation between windows and focusing of a particular named window can be effected by a combination of keystrokes, such as pressing the Alt-Tab keys simultaneously in a Microsoft Windows operating system environment.

24. The electronic commerce system in claim 1 wherein the navigation between the various windows may be effected by use of the “frames” HTML technique.

25. The method in claim 1 wherein the Product Selection Page contains hypertext links that open a web page with additional product information in the Information Window.

26. The method in claim 1 wherein the Product Selection Page may be formatted to display a single product or a plurality of products within a single product selection page.

27. The method in claim 1 wherein the Product Selection Page may consist of text, images, or a combination of text and images.

28. The method in claim 1 wherein the catalog page is of a hierarchical display type

29. The method in claim 1 wherein the catalog page is of a hierarchical display type known as a hyperbolic tree.

30. The method in claim 1 wherein the shipping and payment web pages may be combined into one web page.

31. The method in claim 1 wherein the shipping information may be predetermined and not subject to end user intervention.

32. The method in claim 1 wherein the product selection process may be used in conjunction with a user-furnished shipping/payment/purchase order processing software.

33. The method in claim 1 wherein the product selection process may be used in conjunction with a third-party-furnished shipping/payment/purchase order processing software.
